(19) United States
(12) Patent Application Publication
(10) Pub. No.: US 2011/0197852 A1
(43) Pub. Date: Aug. 18, 2011

(54) Heat engine cycle and internal combustion engine for the same

(76) Inventor: Usher Meyman, Brooklyn, NY (US)

(21) Appl. No.: 12/658,705

(22) Filed: Feb. 16, 2010

(51) Int. Cl. F02B 75/02

(52) U.S. Cl. 123/311

(57) ABSTRACT

The heat engine cycle for four-stroke and six-stroke engines essentially increasing their efficiency, stipulates cessation of suction of a charge before a piston of the engine reaches bottom dead center during the suction stroke and ignited in proportionally decreased volume of combustion chamber. The central angle of a sector of the cams on which their lobes are located is decreased in the inventive engine.

### BACKGROUND OF THE INVENTION

The present invention relates to the heat engine cycle, i.e. to an energy conversion method, and to an internal combustion engine for utilizing this cycle.

The known engines (carburetor or Diesel) work in accordance with the heat cycle comprising the suction, compression, working and exhaust strokes. However, the indicated efficiency of the known cycles is low (about 0.35). Therefore, the efficiency of the engines is also low,

### SUMMARY OF THE INVENTION

Accordingly, it is an object of the present invention to provide the heat engine cycle with the increased indicated efficiency which, therefore, almost doubles the efficiency of the engines.

In keeping with this object, one feature of the present invention resides, briefly stated in cessation of suction of a charge before the end of the suction stroke and diminution in the volume of combustion chamber.

The novel features of the invention are defined in the appended claims. The invention itself will be best understood from the following description and drawings.

### BRIEF DESCRIPTION OF THE DRAWINGS

FIGS. 1, 2 and 3 are p-V diagrams of the inventive heat engine cycles (solid curves) combined with the actual cycles of the existing engines (dash-dot curves) for comparison.

FIGS. 4 and 5 show the contour of the conventional and inventive cams of the engines.

FIG. 6 is a mechanical diagram of an exhaust system.

### DESCRIPTION OF PREFERRED EMBODIMENTS

The curves and points of the p-V diagrams are plotted speculatively and certainly differ from possible experimental data, but even if they some exaggerate positive effects, nevertheless, demonstrate corresponding tendencies.

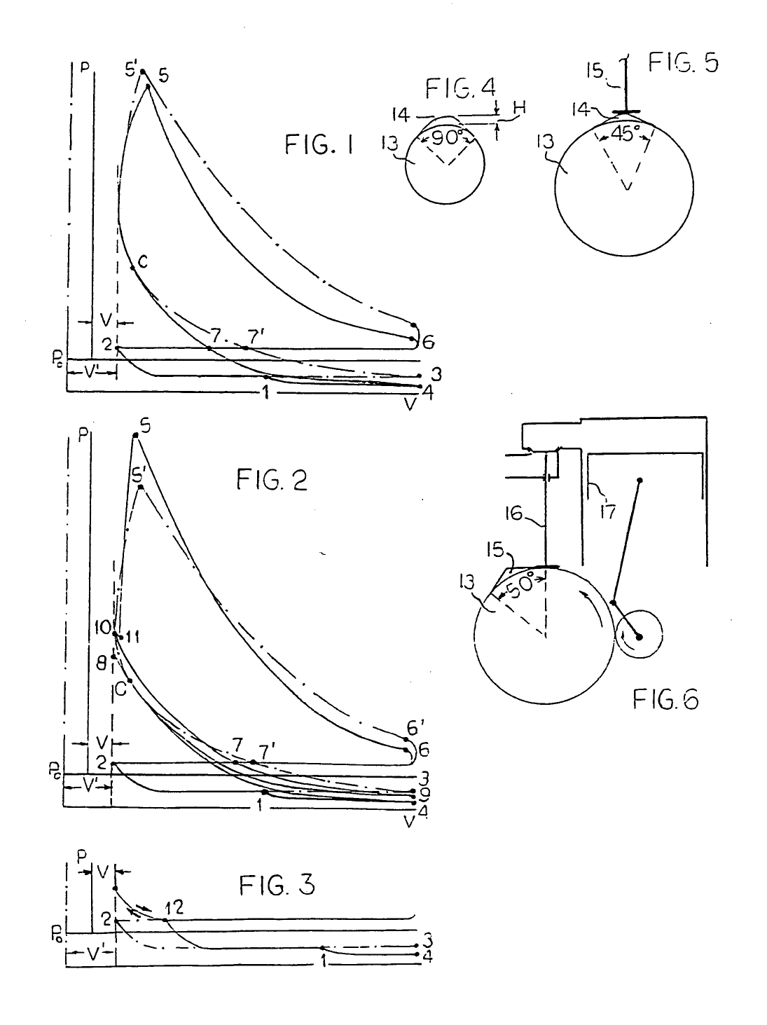

Accordingly to the invention, the heat engine cycle (FIG. 1) includes the suction, compression, working and exhaust strokes, in which suction of a charge (fuel-air or air) is stopped before the end of the suction stroke 3-2 at some point 1 (for example, in the middle of this stroke), i.e. before a piston reaches bottom dead center. After the sharp expansion (curve 1-4), the rarefied and cooled charge which absorbed some heat from walls of working cavity, is compressed and ignited (curve 4-5) in lessened (proportionally to decrease in volume of the charge) compression chamber (V=0.5V′) up to pressure which is conventional (designed) for the engines and may essentially vary (e.g. for carburetor and Diesel engines). Since the charge is decreased half as much, the exhaust gases start to leave working chamber after working stroke 5-6 with the lower temperature and pressure (point 6) in comparison with the known cycle (point 6′).The area of the new circuit 7-5-6-7 is some smaller than the area of the circuit 7′-5′-6′-7′, however, the charge is cut in half. Thus, the indicated efficiency of the inventive heat cycle is increased approximately by 50 to 55%. The decreased power density of the engine may be at least reimbursed in accordance with the second feature of the invention (see FIG. 2).

FIG. 2 shows the p-V diagram of the six-stroke cycle in which the suction of the charge is stopped, for example, in point 1. Then, the charge which is heated by hot walls of working cavity in the course of the interim compression (curve 4-8) and cold (not ignited) expansion (curve 8-9) strokes, returns, therefore, some additional heat into the cycle towards the end of the compression stroke 9-10. Since the combustion velocity of the additionally mixed and heated charge is essentially increased, ignition is stipulated at top dead center 10 or in point 11 near to the latter. This may release quality of fuel from dependence on octane number. The areas of the circuits 7-5-6-7 and 7′-5′-6′-7′ are commensurable while the charge is cut in half. Consequently, the indicated efficiency of the new cycle, as well as the efficiency of the engine, is approximately doubled without losses in the power density. The combustion velocity of the charge may be decreased by increasing the volume of the burnt gas in the mixture. For this purpose, the removal of the burnt gas is stopped in point 12 (FIG. 3) before the end of the exhaust stroke, i.e. before the piston 17 (FIG. 6) reaches top dead center, and then, suction of the fresh charge is started in the same point 12 (or in point near to the latter) of the suction stroke. Besides, the burnt gas returns some heat in the cycle.

A cam 13 (FIG. 4) of the camshaft of the known four-stroke engine has a lobe 14 located on the arch of a sector with the central angle of substantially 90 degrees. Accordingly, for a version corresponding to location of point 1 in FIG. 1, the central angle of the inventive cam 13 interacting with a suction valve 15 directly (or through one or more elements; not shown) should be of about 45 degrees (FIG. 5). For the inventive four-stroke engine, the reasonable range of the central angles is 30 to 80 degrees. The height of the lobes 14 may be retained by appropriate increase of diameter of the cams. Otherwise, diameter of the valves should be increased.

The lobes 14 of the known six-stroke engine are located on the arch of a sector with the central angle of substantially 60 degrees. Accordingly, for a version corresponding to location of point 1 in FIG. 2, the central angle should be of about 30 degrees. For the inventive six-stroke engine, the reasonable range of the central angles is 20 to 50 degrees.

A lobe 15 (FIG. 6) interacting with an exhaust valve 16 in accordance with p-V diagram (FIG. 3) is located on the arch of a sector the central angle of which is decreased for about 10 degrees. The reasonable range of the central angles of the sector of the exhaust cam 13 is 30 to 55 degrees.

The invention is not limited to the details shown since various modifications and structural changes are possible without departing in any way from the spirit of the present invention.

What is claimed is:

1. The heat engine cycle for an internal combustion engine having at least one piston periodically reaching bottom and top dead centers, comprising the suction of a charge, compression of the charge; working and exhaust of the burnt gas strokes, wherein said suction of the charge is stopped before said piston reaches said bottom dead center, and then the charge is compressed up to conventional pressure.

2. The heat engine cycle as defined in claim 1, and further comprising the interim compression and cold expansion strokes after said suction stroke.

3. The heat engine cycle as defined in claims 2, in which removal of the burnt gas is stopped before said piston reaches said top dead center, and said suction is started at the substantially same position of said piston during said suction stroke.

4. An internal combustion engine for utilizing the heat engine cycle of claim 1, comprising at least one pair of an interacting suction valve and a cam having a lobe located on the arch of a sector of said cam, wherein the central angle of said sector is in a range of 30 to 80 degrees.

5. An internal combustion engine for utilizing the heat engine cycle of claim 2, comprising at least one pair of an interacting suction valve and a cam having a lobe located on the arch of a sector of said cam, wherein the central angle of said sector is in a range of 20 to 50 degrees.

6. The internal combustion engine for utilizing the heat engine cycle of claim 3, as defined in claim 5 and farther comprising at least one pair of an interacting exhaust valve and a cam having a lobe located on a sector of said exhaust cam, wherein central angle of said sector is in a range of 30 to 55 degrees.
